(19) United States
(12) Patent Application Publication
(10) Pub. No.: US 2025/0045522 A1
(43) Pub. Date: Feb. 6, 2025

(54) EXTRACTION DEVICE

(71) Applicant: NEC Corporation, Minato-ku, Tokyo (JP)

(72) Inventor: Jun YOSHIDA, Tokyo (JP)

(73) Assignee: NEC Corporation, Minato-ku, Tokyo (JP)

(21) Appl. No.: 18/718,154

(22) PCT Filed: Dec. 22, 2021
(86) PCT No.: PCT/JP2021/047621

§ 371 Date: Jun. 10, 2024

(51) Int. Cl. G06F 40/284; G06F 40/205; G06F 40/30

(52) U.S. Cl. CPC G06F 40/284; G06F 40/205; G06F 40/30

(57) ABSTRACT

An extraction device 400 includes: an acquisition section 421 acquiring a first natural sentence input by a user; an extraction section 422 extracting at least a target word of a relevant word and the target word from the first natural sentence acquired by the acquisition section 421 using a model learnt to output the relevant word and the target word with a second natural sentence as an input, the relevant word being a word defining the relevancy between words included in the second natural sentence and the target word being a word serving as the target of the relevant word; and an output section 423 outputting the target word extracted by the extraction section 422.

### TECHNICAL FIELD

The present invention relates to an extraction device, an extraction method, and a recording medium.

### BACKGROUND ART

A technology is known which is used in analyzing character information of posted words-of-mouth and the like.

For example, Patent Literature 1 describes an information extraction system of extracting words relevant to positive expressions and words relevant to negative expressions by applying predetermined processing to a language analysis result using an opinion/feeling dictionary storing opinion/feeling words relevant to absolute positive expressions and opinion/feeling words relevant to absolute negative expressions, the opinion/feeling words having a polarity remaining unchanged regardless of a context.

### CITATION LIST

### Patent Literature

Patent Literature 1: International Publication No. WO 2014/065392

### SUMMARY OF INVENTION

### Technical Problem

Even when the dictionary can be prepared in advance, and then the words in the dictionary can be extracted as described in Patent Literature 1, there is necessity of extracting words indicating factors of evaluations, such as “positive” or “negative”, to determine what factors have contributed to the evaluations. Herein, methods for extracting words indicating the factors of the evaluations include a method in which target words are extracted using an attention and dependency analysis through a feeling analysis using the BERT (Bidirectional Encoder Representations from Transformers) or the like, for example. However, the dependency analysis result is sensitive to orthographic variants. This has made it difficult to extract the target word on a rule basis from the dependency analysis. Thus, there has been a problem of difficulty in analyzing character information and extracting words indicating factors of the evaluations, such as “positive” or “negative”, or suggestions, such as requests, from customers.

Thus, it is an object of the present invention to provide an extraction device, an extraction method, and a recording medium capable of solving the problem of difficulty in analyzing character information and extracting words indicating factors of the evaluations, such as “positive” or “negative”, or suggestions, such as requests, from customers.

### Solution to Problem

To achieve the above-described object, an extraction device, which is one form of this disclosure, is configured to include:
an acquisition section acquiring a first natural sentence input by a user;
an extraction section extracting at least a target word of a relevant word and the target word from the first natural sentence acquired by the acquisition section using a model learnt to output the relevant word and the target word with a second natural sentence as an input, the relevant word being a word defining the relevancy between words included in the second natural sentence and the target word being a word serving as the target of the relevant word; and
an output section outputting the target word extracted by the extraction section.

An extraction method, which is another form of this disclosure, is configured to include:
acquiring a first natural sentence input by a user;
extracting at least a target word of a relevant word and the target word from the acquired first natural sentence using a model learnt to output the relevant word and the target word with a second natural sentence as an input, the relevant word being a word defining the relevancy between words included in the second natural sentence and the target word being a word serving as the target of the relevant word; and
outputting the extracted target word,
the acquiring, the extracting, and the outputting being performed by an information processing device.

A computer-readable recording medium, which is another form of this disclosure, storing a program for causing an information processing device to realize processing of:
acquiring a first natural sentence input by a user;
extracting at least a target word of a relevant word and the target word from the acquired first natural sentence using a model learnt to output the relevant word and the target word with a second natural sentence as an input, the relevant word being a word defining the relevancy between words included in the second natural sentence and the target word being a word serving as the target of the relevant word; and
outputting the extracted target word.

### Advantageous Effects of Invention

The above-described configurations make it possible to provide the extraction device, the extraction method, and the recording medium capable of solving the problem of difficulty in analyzing character information and extracting words indicating factors of the evaluations, such as “positive” or “negative”, or suggestions, such as requests, from customers.

### BRIEF DESCRIPTION OF DRAWINGS

FIG. 1 is a diagram for explaining the outline of the present invention.

FIG. 2 is a block diagram illustrating a configuration example of an extraction device in a first example embodiment of this disclosure.

FIG. 3 is a diagram for explaining an example of parsing.

FIG. 4 is a diagram for explaining an example of labeling.

FIG. 5 is a flowchart showing an operation example of the extraction device.

FIG. 6 is a flowchart showing an operation example of the extraction device.

FIG. 7 is a block diagram illustrating another configuration example of the extraction device.

FIG. 8 is a block diagram illustrating a configuration example of an extraction device in a second example embodiment of this disclosure.

FIG. 9 is a diagram illustrating an extraction example in the extraction device.

FIG. 10 is a diagram illustrating an output example in the extraction device.

FIG. 11 is a block diagram illustrating a configuration example of an extraction device in a third example embodiment of this disclosure.

FIG. 12 is a diagram illustrating an extraction example in the extraction device.

FIG. 13 is a diagram illustrating an output example in the extraction device.

FIG. 14 is a diagram illustrating a hardware configuration example of an extraction device in a fourth example embodiment of this disclosure.

FIG. 15 is a block diagram illustrating a configuration example of the extraction device.

FIG. 16 is a block diagram illustrating a configuration example of a request extraction device.

### DESCRIPTION OF EMBODIMENTS

### First Example Embodiment

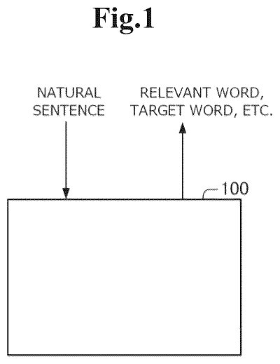

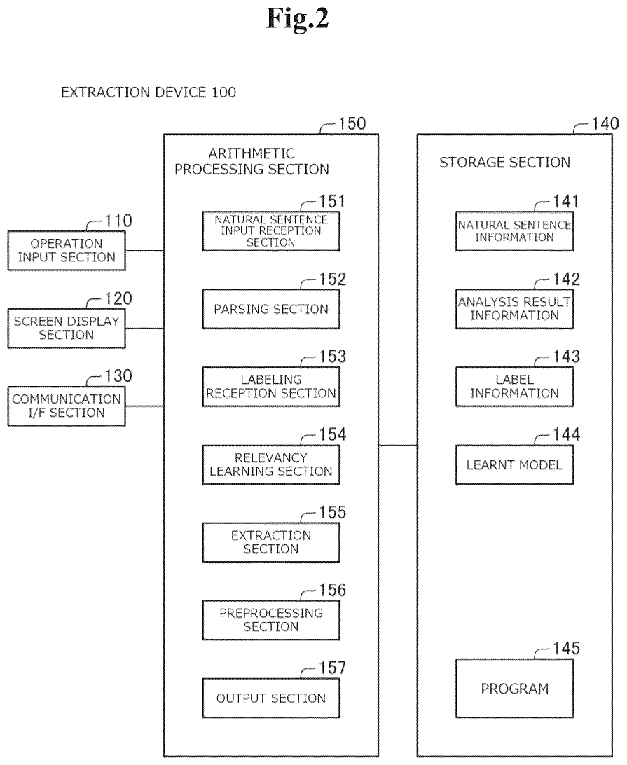

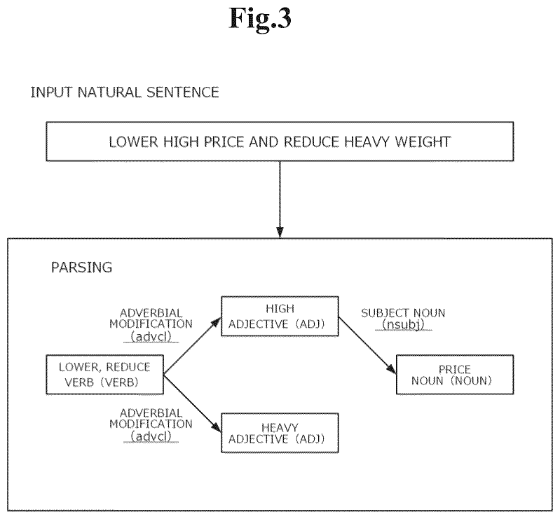

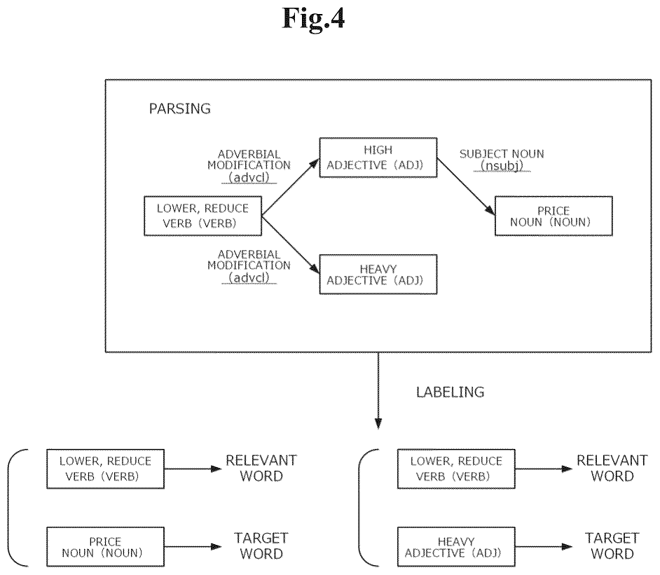

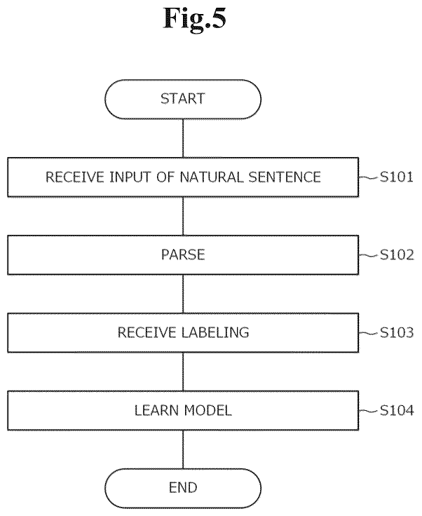

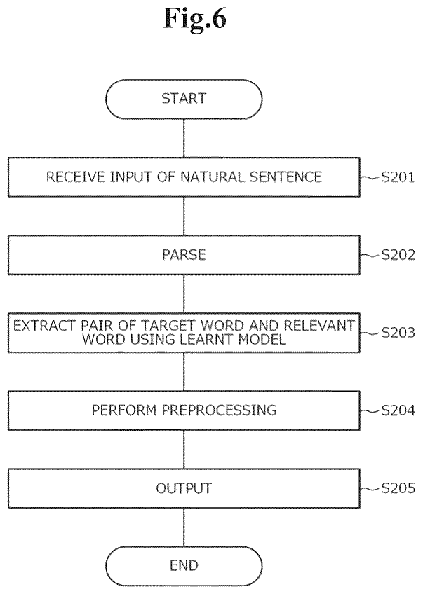

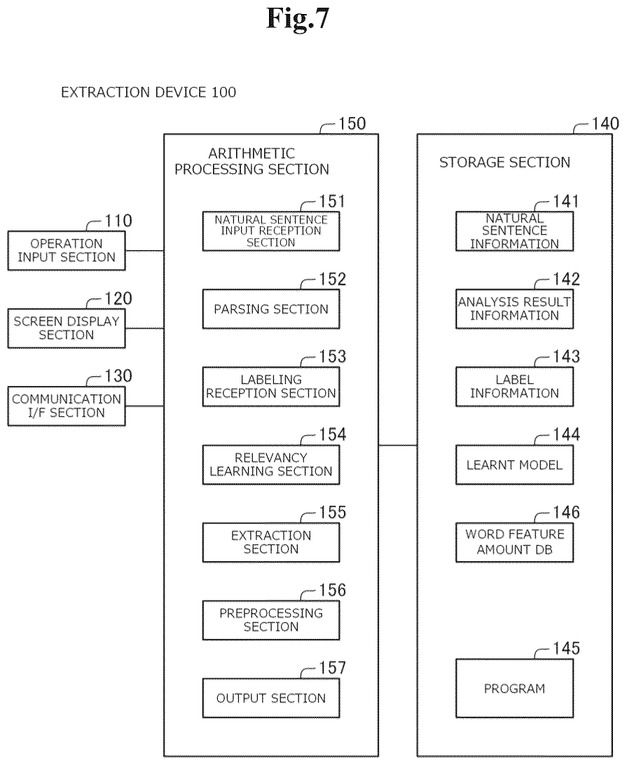

A first example embodiment of this disclosure is described with reference to FIGS. 1 to 7. FIG. 1 is a diagram for explaining the outline of the present invention. FIG. 2 is a block diagram illustrating a configuration example of an extraction device 100. FIG. 3 is a diagram for explaining an example of parsing. FIG. 4 is a diagram for explaining an example of labeling. FIGS. 5 and 6 are flowcharts showing operation examples of the extraction device 100. FIG. 7 is a block diagram illustrating another configuration example of the extraction device.

The first example embodiment of this disclosure describes the extraction device 100 that is an information processing device extracting and outputting at least one of a pair of a relevant word and a target word from an input natural sentence (or natural language sentence) as illustrated in FIG. 1. For example, at a model learning stage, a plurality of natural sentences (e.g., second natural sentences), such as words-of-mouth, is input into the extraction device 100. Then, the extraction device 100 applies predetermined parsing to the input natural sentences. Further, the extraction device 100 receives an input of labeling for the pair of the relevant word and the target word after the parsing. Then, the extraction device 100 performs machine learning processing with the parsing result and the labeled result as an input, thereby generating a learnt model extracting and outputting the relevant word and the target word from the natural sentence. The learnt model may be learnt to output only either one determined in advance of the relevant word and the target word.

For example, a plurality of natural sentences (e.g., first natural sentences), such as words-of-mouth, is input into the extraction device 100 in use. Then, the extraction device 100 applies parsing or the like to the input natural sentences, and then inputs the natural sentences after the parsing or the like in the above-described learnt model, thereby extracting a pair of a relevant word and a target word from the natural sentence. Then, the extraction device 100 performs preprocessing as required, and then outputs the extracted result.

In this example embodiment, the relevant word refers to a word defining the relevancy between words. For example, when the relevancy of “positive” is defined between words, words, such as “good” and “happy” (e.g., words indicating positive feelings), serve as the relevant word. For example, when the relevancy of “negative” is defined between words, words, such as “boring” and “bad taste” (e.g., words indicating negative feelings), serve as the relevant word. The relevancy defined between words may include, in addition to the words indicating feelings, such as “positive” and “negative”, words indicating requests and other optional suggestions. The relevancy defined between words may include relevancy other than those exemplified above. For example, the relevant words refer to words indicating feelings of users, such as “positive” or “negative”, or words indicating requests of users as described above.

In this example embodiment, the target word means a word related to the relevant word. For example, for the relevant words defining the relevancy defining “positive”, such as “good” and “happy”, a part of “what” of “what was good” serves as the target word. As an example, in the case of “This hot spring had good hot spring quality.”, the “hot spring quality” serves as the target word. Thus, the target word includes a word indicating the factor of the relevancy indicated by the relevant word and is paired with the relevant word. In other words, the target word refers to a word serving as the target of the relevant word.

For example, the extraction of semantic relevancy defined between words from a natural sentence requires the extraction of such relevancy that a meaning is given by the combination of a word pair. For example, in a sentence “Even though it is an old personal computer, it has good spec.”, even when only the word “spec” is extracted, it is not clear what meaning a writer of the sentence given to the spec (giving relevancy). The same applies to a case where only the word “good” is extracted. By extracting the combination of “spec, good”, it can be understood that a user gives a meaning “good” to “spec”,” i.e., gives positive relevancy. Thus, the specification of the semantic relevancy between words from natural sentences requires the extraction of the relevancy of “giving a meaning” between words. Therefore, the extraction device 100 described in this example embodiment learns a model to be able to extract a pair of the relevant word and the target word described above from a natural sentence.

FIG. 2 illustrates a configuration example of the extraction device 100. Referring to FIG. 2, the extraction device 100 has an operation input section 110, a screen display section 120, a communication I/F section 130, a storage section 140, and an arithmetic processing section 150, for example, as main constituent components.

FIG. 2 illustrates an example of a case in which the functions as the extraction device 100 are realized using one information processing device. However, the extraction device 100 may be realized using a plurality of information processing devices, e.g., realized on the cloud. For example, the functions as the extraction device 100 may be realized by two information processing devices of a learning device having the functions as a natural sentence input reception section 151, a parsing section 152, a labeling reception section 153, and a relevancy leaming section 154, which are described later, and an extraction device having the functions as the natural sentence input reception section 151, the parsing section 152, an extraction section 155, a preprocessing section 156, and an output section 157, which are described later. The extraction device 100 does not have to include some of the configurations exemplified above, e.g., not having the operation input section, or may have configurations other than the configurations exemplified above.

The operation input section 110 contains operation input devices, such as a keyboard and a mouse. The operation input section 110 detects an operation of an operator operating the extraction device 100 and outputs the detected operation to the arithmetic processing section 150.

The screen display section 120 contains a screen display device, such as a liquid crystal display (LCD). The screen display section 120 can display various kinds of information stored in the storage section 140 on a screen in response to an instruction from the arithmetic processing section 150.

The communication I/F section 130 contains a data communication circuit and the like. The communication I/F section 130 performs data communication with an external device or the like connected via a communication line.

The storage section 140 is a storage device, such as a hard disk or a memory. The storage section 140 stores processing information and a program 145 required for various kinds of processing in the arithmetic processing section 150. The program 145 realizes various processing sections by being read into the arithmetic processing section 150 to be executed. The program 145 is previously read in advance from the external device or the recoding medium via a data input/output function, such as the communication I/F section 130, and stored in the storage section 140. Main information stored in the storage section 140 includes natural sentence information 141, analysis result information 142, label information 143, a learnt model 144, and the like, for example.

A natural sentence information 141 includes one or two or more natural sentences, the input of which is received by the natural sentence input reception section 151. As an example, the natural sentence includes words of mouth by users in electronic commerce (EC) sites, product reviews, social networking services (SNS), and the like. The natural sentence may be one other than those exemplified above, e.g., collected product reviews or questionnaire results. For example, the natural sentence information 141 is updated when the natural sentence input reception section 151 receives an input of a natural sentence in model learning or in use of a learnt model.

For example, the natural sentence information 141 includes a natural sentence for learning (second natural sentence) and a natural sentence in use (first natural sentence) to be distinguished from each other. Among the natural sentences that can be included in the natural sentence information 141, the natural sentence for learning may be deleted at a stage when the learning by the relevancy learning section 154 described later has been completed, for example. Further, among the natural sentences that can be included in the natural sentence information 141, the natural sentence in use may also be deleted as appropriate as necessary.

The analysis result information 142 includes information according to the result of the parsing of the natural sentence included in the natural sentence information 141 by a parsing section 152 described later. For example, the analysis result information 142 is updated at each time of applying the parsing to the natural sentence included in the natural sentence information 141 by the parsing section 152 described later.

As an example, the analysis result information 142 includes parts of speech (e.g., part-of-speech tags) that are word types in word units obtained by dividing the natural sentence by a morpheme analysis or the like and dependency information (e.g., dependency tags) indicating the relevancy between words. For example, FIG. 3 illustrates an example of parsing processing for a natural sentence including a request of lowering the high price and reducing the heavy weight of a user. As illustrated in FIG. 3, the natural sentence is divided into words of “price”, “high”, “heavy”, and “lowering, reducing” by a morpheme analysis in parsing. Therefore, the analysis result information 142 includes information indicating the part of speech of each of the divided words, the relevancy between the words, and the like. For example, in the example illustrated in FIG. 3, the analysis result information 142 includes the part of speech of each word obtained by dividing the natural sentence, the dependency information between the words, and the like, such as information of the part-of-speech tag indicating that the part-of-speech of the word “lowering, reducing” is a “verb”, for example, or the dependency tag indicating that there is relevancy of “adverbial clause modification” between the words of “reducing” and “heavy”. The part-of-speech tag and the dependency tag may be known tags.

The label information 143 includes information according to the result of labeling the words contained in the analysis result information 142. For example, the label information 143 is updated at each time when the labeling reception section 153 described later receives the labeling.

In the case of this example embodiment, the label information 143 includes information indicating that a word is attached with a label indicating that the word is the relevant word and information indicating that a word is attached with a label indicating that the word is the target word corresponding to the relevant word. For example, FIG. 4 illustrates an example of the labeling according to the parsing result illustrated in FIG. 3. As illustrated in FIG. 4, when the parsing as illustrated in FIG. 3 is performed, an operator or the like of the extraction device 100 attaches a label of the relevant word to the word “lowering” and attaches a label of the target word to the word “price”, for example. Therefore, the label information 143 includes the information indicating that the word “lowering” is attached with the label indicating that the word is the relevant word and the information indicating that the word “price” is attached with the label indicating that the word is the target word corresponding to the relevant word.

The learnt model 144 includes a model that has been subjected to machine learning processing based on the labeled result. For example, the model included in the learnt model 144 is learnt and adjusted to extract and output the relevant word and the target word for an input natural sentence (natural sentence after parsing). For example, the learnt model 144 is updated in response to the learning performed by the relevancy learning section 154 described later based on the labeled result. As described in a second example embodiment and a third example embodiment, the learnt model 144 may include a model for each relevancy defined by the relevant word.

The arithmetic processing section 150 has an arithmetic processing device, such as a central processing unit (CPU), and peripheral circuits of the arithmetic processing device. The arithmetic processing section 150 reads the program 145 from the storage section 140 and executes the program 145, thereby making the hardware and the program 145 described above cooperate with each other and realizing various processing sections. Main processing sections realized by the arithmetic processing section 150 include the natural sentence input reception section 151, the parsing section 152, the labeling reception section 153, the relevancy learning section 154, the extraction section 155, the preprocessing section 156, the output section 157, and the like, for example. Among the main processing sections realized by the arithmetic processing section 150, the natural sentence input reception section 151, the parsing section 152, the labeling reception section 153, and the relevancy learning section 154 mainly operate in model learning. Among the main processing sections realized by the arithmetic processing section 150, the natural sentence input reception section 151, the parsing section 152, the extraction section 155, the preprocessing section 156, and the output section 157 mainly operate in use of the learnt model.

The natural sentence input reception section 151 receives an input of a natural sentence. In other words, the natural sentence input reception section 151 acts as an acquisition section acquiring a natural sentence. For example, the natural sentence input reception section 151 receives an input of a natural sentence from an external device or the like via the communication I/F section 130 or receives an input of a natural sentence in response to an operation using the operation input section 110. The natural sentence input reception section 151 stores the received natural sentence in the storage section 140 as the natural sentence information 141.

For example, the natural sentence input reception section 151 receives an input of a plurality of natural sentences, such as words-of-mouth by users in EC sites, product reviews, SNSs, and the like and questionnaire results. The natural sentence input reception section 151 may also receive an input of natural sentences other than those exemplified above.

The natural sentence input reception section 151 can receive an input of a natural sentence each in model learning and in use of a learnt model as described above. The natural sentence input reception section 151 may store a natural sentence for learning (second natural sentence) and a natural sentence in use (first natural sentence) to be distinguishable from each other in the storage section 140.

The parsing section 152 applies parsing to the natural sentence received by the natural sentence input reception section 151. Then, the parsing section 152 stores the analysis result as the analysis result information 142 in the storage section 140.

For example, the parsing section 152 applies a morpheme analysis to a natural sentence, and then applies a dependency analysis or the like to the natural sentence, thereby determining the part of speech that is the word type and the dependency information indicating the relevancy between words in word units obtained by dividing the natural sentence. For example, in the case of a natural sentence illustrated in FIG. 3, the parsing section 152 performs a morpheme analysis to divide the natural sentence illustrated in FIG. 3 into words, such as “price,” “high,” “heavy,” and “lowering, reducing”. Further, the parsing section 152 determines the parts of speech of the divided words and determines the relevancy between the words by performing a dependency analysis or the like. For example, when exemplified in FIG. 3, the parsing section 152 determines that the part of speech of the word “reducing” is a “verb” and determines that there is relevancy of “adverbial clause modification” between “reducing” and “heavy”. Thereafter, the parsing section 152 stores the parts of speech, the dependency information, and the like specified by the above-described determination as the analysis result information 142 in the storage section 140. The parsing section 152 may perform the parsing using a known parsing device.

As described above, the parsing section 152 may perform the parsing for a natural sentence both in model learning and in use of a learnt model.

The labeling reception section 153 receives, after the parsing section 152 has performed the parsing, the attachment of a label to a word by receiving an operation of an operator to the operation input section 110, for example, in model learning. Then, the labeling reception section 153 stores information indicating the received label as the label information 143 in the storage section 140.

For example, the labeling reception section 153 causes, after the parsing section 152 has performed the parsing, the screen display section 120 or the like to display the parsing result. Then, the labeling reception section 153 receives labeling to the target word and the relevant word from an operator of the extraction device 100. For example, when exemplified in FIG. 4, the labeling reception section 153 receives an input of attaching a label of the relevant word to the word “lowering” and a label of the target word corresponding to the relevant word above to the word “price”. The labeling reception section 153 receives an input of attaching the label of the relevant word to the word “reducing” and attaching the label of the target word label corresponding to the relevant word above to the word “heavy”. Thereafter, the labeling reception section 153 stores information according to the reception result above as the label information 143 in the storage section 140.

For example, the labeling reception section 153 can receive information of attaching one or two or more pairs of labels to one natural sentence as described above. As an example, the labeling reception section 153 may receive the labeling for each token, which is a group of words having relevancy. When exemplified in FIG. 4, there is relevancy of adverbial clause modification between the words “reducing” and “heavy” and there is relevancy of adverbial clause modification and a subject noun between the words “lowering”, “high”, and “price”. Thus, the labeling reception section 153 can receive the labeling for the token of “reducing” and “heavy” and the labeling for the token of “lowering”, “high”, and “price”. The labeling reception section 153 may receive the label information from an external device or the like by transmitting the parsing result to an external device or the like via the communication I/F section 130, or the like, for example.

The relevancy learning section 154 learns a model to extract and output the relevant word and the target word for the input natural sentence after parsing by adjusting a weight value of a neural network with the result received by the labeling reception section 153 and the parsing result as an input. Then, the relevancy learning section 154 stores the learnt model as the learnt model 144 in the storage section 140. The relevancy learning section 154 may adjust the weight value by inputting the result received by the labeling reception section 153 for each token determined according to the result of the dependency analysis performed by the parsing section 152. Further, the relevancy learning section 154 may learn a model for each relevancy defined by the relevant word.

The extraction section 155 inputs the result of the parsing performed by the parsing section 152 in the model indicated by the learnt model 144 in use of the learnt model, thereby extracting a pair of the relevant word and the target word corresponding to the natural sentence. For example, the extraction section 155 can extract a pair of the relevant word and the target word for each token determined as the result of the parsing.

The extraction section 155 does not necessarily have to extract and output both the relevant word and the target word insofar as it is configured to extract and output at least one of the pair of the relevant word and the target word. For example, the extraction section 155 may be configured to extract and output only the target word.

The preprocessing section 156 applies predetermined preprocessing to the result output by the extraction section 155. For example, the preprocessing section 156 applies preprocessing for visualizing the factor of the relevancy defined by the relevant word to the target word extracted by the extraction section 155.

For example, the preprocessing section 156 can apply clustering using K-means or the like to an output by the extraction section 155. Further, the preprocessing section 156 can perform graphing of totalizing the appearance frequencies of the target word output by the extraction section 155, and then creating a graph showing the totalization result. The preprocessing section 156 may be configured to perform preprocessing, such as processing of visualizing a plurality of outputs by the extraction section 155 other than those exemplified above, and then output the preprocessing result. Thus, the preprocessing section 156 groups the target words extracted by the extraction section 155 based on the similarity of the words or totalizes and graphs the appearance frequencies or the like of the target word, thereby visualizing the factor of the relevancy.

The preprocessing section 156 may be configured to perform preprocessing by a method determined in advance according to the type of the relevant word or the like, for example. The preprocessing section 156 may be configured to perform the preprocessing exemplified above when predetermined conditions are satisfied.

The output section 157 outputs the result of the preprocessing performed by the preprocessing section 156. For example, the output section 157 causes the screen display section 120 to display the result of the preprocessing performed by the preprocessing section 156 or transmits the result to an external device via the communication I/F section 130. The output section 157 may output the result output by the extraction section 155 together with the result of the preprocessing performed by the preprocessing section 156 or in place of the result of the preprocessing performed by the preprocessing section 156.

The description above gives the configuration example of the extraction device 100. Subsequently, an operation example of the extraction device 100 is described with reference to FIGS. 5 and 6.

FIG. 5 is a flowchart showing an operation example of the extraction device 100 in learning. Referring to FIG. 5, the natural sentence input reception section 151 receives an input of a natural sentence (Step S101).

The parsing section 152 applies parsing to a natural sentence received by the natural sentence input reception section 151 (Step S102). For example, the parsing section 152 applies a morpheme analysis to a natural sentence, and then applies a dependency analysis to the natural sentence, for example, thereby determining the part of speech that is the word type and the dependency information indicating the relevancy between words in word units obtained by dividing the natural sentence.

The labeling reception section 153 detects an operation of an operator to the operation input section 110 after the parsing section 152 has performed the parsing, thereby receiving the attachment of labels to words (Step S103). For example, the labeling reception section 153 receives the attachment of a label indicating that the word is the relevant word and a label indicating that the word is the target word.

The relevancy learning section 154 learns a model to extract and output the relevant word and the target word for the input natural sentence by adjusting a weight value in a weight matrix, for example, with the result received by the labeling reception section 153 as an input (Step S104).

The description above gives an operation example of the extraction device 100 in learning. Subsequently, an operation example of the extraction device 100 in use of a learnt model is described with reference to FIG. 6.

FIG. 6 is a flowchart showing an operation example of the extraction device 100 in use of a learnt model. Referring to FIG. 6, the natural sentence input reception section 151 receives an input of a natural sentence (Step S201).

The parsing section 152 applies parsing to a natural sentence received by the natural sentence input reception section 151 (Step S202). For example, the parsing section 152 applies a morpheme analysis to a natural sentence, and then applies a dependency analysis to the natural sentence, for example, thereby determining the part of speech that is the word type and the dependency information indicating the relevancy between words in word units obtained by dividing the natural sentence.

The extraction section 155 inputs the result of the parsing performed by the parsing section 152 in a model indicated by the learnt model 144, thereby extracting a pair of the relevant word and the target word corresponding to the natural sentence (Step S203). For example, the extraction section 155 can extract a pair of the relevant word and the target word for each token determined as the result of the parsing.

The preprocessing section 156 applies predetermined preprocessing to the result output by the extraction section 155 (Step S204). The processing of Step S205 may be skipped.

The output section 157 outputs the result of preprocessing performed by the preprocessing section 156 (Step S205). The output section 157 may be configured to output the result output by the extraction section 155 together with the result of the preprocessing performed by the preprocessing section 156 or in place of the result of the preprocessing performed by the preprocessing section 156.

The description above gives an operation example of the extraction device 100 in use of a learnt model.

Thus, the extraction device 100 has the extraction section 155. Such a configuration enables the extraction section 155 to extract a pair of the relevant word and the target word from a natural sentence using the model learnt to extract the pair of the relevant word and the target word. This enables the extraction device 100 to extract and output the target word indicating the factor of the relevant word.

The extraction device 100 further has the preprocessing section 156. This configuration enables the output section 157 to output the result of the preprocessing performed by the preprocessing section 156. As a result, a user can easily understand the factor or the like of the relevancy defined by the relevant word.

This example embodiment describes the configuration example of the extraction device 100. However, the extraction device 100 may have a configuration other than the configurations exemplified in this example embodiment. For example, FIG. 7 illustrates another configuration example of the extraction device 100. Referring to FIG. 7, the storage section 140 possessed by the extraction device 100 may have a word feature amount DB 146 in addition to the configurations exemplified in this example embodiment. When the storage section 140 has the word feature amount DB 146, the relevancy learning section 154 may be configured to learn a model by additionally inputting the feature amount for each word indicated by the word feature amount DB 146. Thus, by preparing the word feature amount DB 146 and performing learning while adding the meanings of words, the enhancement of the extraction accuracy can be expected.

### Second Example Embodiment

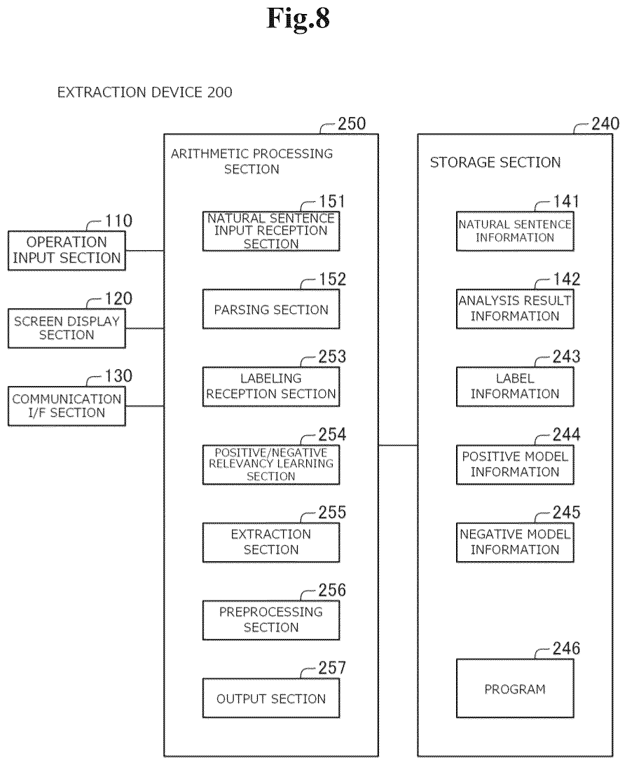

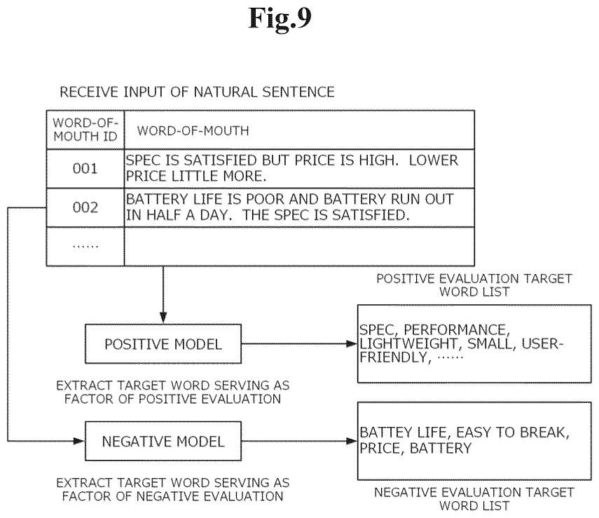

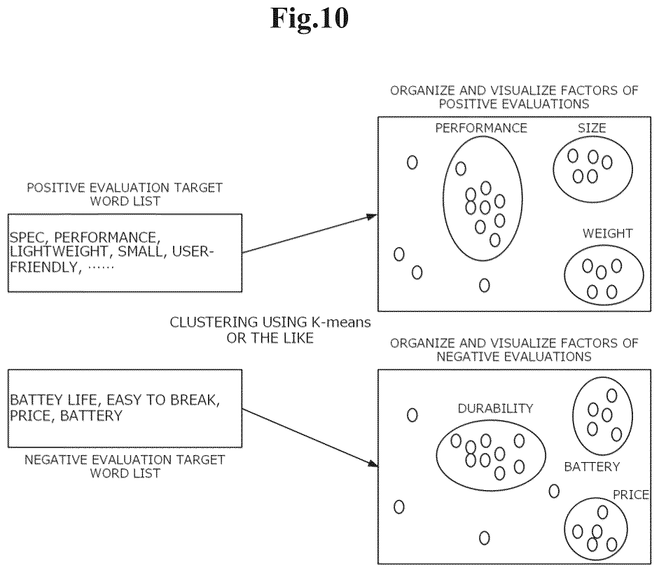

Next, a second example embodiment of this disclosure is described with reference to FIGS. 8 to 10. FIG. 8 is a block diagram illustrating a configuration example of an extraction device 200. FIG. 9 is a diagram illustrating an extraction example in the extraction device 200. FIG. 10 is a diagram illustrating an output example in the extraction device 200.

The second example embodiment of this disclosure describes the extraction device 200 that is an information processing device extracting and outputting at least one of a pair of the relevant word and the target word from an input natural sentence as with the extraction device 100 described in the first example embodiment. As described later, the extraction device 200 described in this example embodiment has a positive model extracting a pair of the relevant word defining relevancy of “positive” and the target word, and a negative model extracting a pair of the relevant word defining relevancy of “negative” and the target word. Then, the extraction device 200 inputs natural sentences, such as words-of-mouth and product reviews, in each model, thereby extracting the target word indicating the factor leading to the positive/negative evaluation. Further, the extraction device 200 can visually present the factor of good/bad for a user by clustering the extracted target words by positive/negative.

FIG. 8 illustrates a configuration example of the extraction device 200. Referring to FIG. 8, the extraction device 200 has the operation input section 110, the screen display section 120, the communication I/F section 130, a storage section 240, and an arithmetic processing section 250, for example, as main constituent components.

FIG. 8 illustrates an example in which the functions as the extraction device 200 are realized using one information processing device, but various modifications may be adopted as the configuration of the extraction device 200 as with the extraction device 100. Hereinafter, configurations characteristic in this example embodiment and different from the configurations of the extraction device 100 among the configurations of the extraction device 200 are described.

The storage section 240 is a storage device, such as a hard disk or a memory. The storage section 240 stores processing information and a program 246 required for various kinds of processing in the arithmetic processing section 250. The program 246 realizes various processing sections by being read into the arithmetic processing section 250 to be executed. The program 246 is read in advance from an external device or a recoding medium via a data input/output function, such as the communication I/F section 130, to be stored in the storage section 240. Main information stored in the storage section 240 includes the natural sentence information 141, the analysis result information 142, label information 243, positive model information 244, negative model information 245, and the like, for example.

The label information 243 includes information according to results of labeling the words contained in the analysis result information 142. For example, the label information 243 is updated at each time when a labeling reception section 253 described later receives the labeling.

In the case of this example embodiment, the label information 243 includes information indicating that a word is attached with a label indicating that the word is the relevant word defining the relevancy of “positive” and information indicating that a word is attached with a label indicating that the word is the target word corresponding to the relevant word. Further, the label information 243 includes information indicating that a word is attached with a label indicating that the word is the relevant word defining the relevancy of “negative” and information indicating that a word is attached with a label indicating that the word is the target word corresponding to the relevant word.

The positive model information 244 includes a model that has been subjected to machine learning processing based on the result of labeling the relevant word defining the relevancy of “positive” and the target word corresponding to the relevant word among the labeled results. For example, the positive model included in the positive model information 244 is learnt and adjusted to extract and output the relevant word defining the relevancy of “positive” and the target word for the input natural sentence (natural sentence after parsing). For example, the positive model information 244 is updated in response to the learning based on the result of labeling the relevant word defining the relevancy of “positive” and the target word corresponding to the relevant word performed by a positive/negative relevancy learning section 254 described later.

The negative model information 245 includes a model that has been subjected to machine learning processing based on the result of labeling the relevant word defining the relevancy of “negative” and the target word corresponding to the relevant word among the labeled results. For example, the negative model included in the negative model information 245 is learnt and adjusted to extract and output the relevant word defining the relevancy of “negative” and the target word for the input natural sentence (natural sentence after parsing). For example, the negative model information 245 is updated in response to the learning performed based on the result of labeling the relevant word defining the relevancy of “negative” and the target word corresponding to the relevant word by the positive/negative relevancy learning section 254 described later.

The arithmetic processing section 250 has an arithmetic processing device, such as the central processing unit (CPU), and peripheral circuits of the arithmetic processing device. The arithmetic processing section 250 reads the program 246 from the storage section 240 and executes the program 246, thereby making the hardware and the program 246 described above cooperate with each other and realizing various processing sections. Main processing sections realized by the arithmetic processing section 250 include the natural sentence input reception section 151, the parsing section 152, the labeling reception section 253, the positive/negative relevancy learning section 254, an extraction section 255, a preprocessing section 256, an output section 257, and the like, for example.

The labeling reception section 253 receives the attachment of labels to words by receiving an operation of an operator to the operation input section 110 after the parsing section 152 has performed the parsing in model learning. Then, the labeling reception section 253 stores information indicating the received label as the label information 243 in the storage section 240.

In the case of this example embodiment, the labeling reception section 253 receives labels for the relevant word defining the relevancy of “positive” and the target word corresponding to the relevant word and also receives labels for the relevant word defining the relevancy of “negative” and the target word that corresponding to the relevant word. The labeling reception section 253 may receive the labeling from an external device or the like as with the labeling reception section 153 described in the first example embodiment.

The positive/negative relevancy learning section 254 learns a model to extract and output the relevant word and the target word for the input natural sentence after parsing by adjusting a weight value in a weight matrix, for example, with the result received by the labeling reception section 253 and the parsing result as an input as with the relevancy learning section 154. In the case of this example embodiment, the positive/negative relevancy learning section 254 learns a positive model based on the result of labeling the relevant word defining the relevancy of “positive” and the target word corresponding to the relevant word among the labeled results. Further, the positive/negative relevancy learning section 254 learns a negative model based on the result of labeling the relevant word defining the relevancy of “negative” and the target word corresponding to the relevant word among the labeled results. Thus, the positive/negative relevancy learning section 254 learns a model for each relevancy defined by the relevant word.

The extraction section 255 extracts and outputs a pair of the relevant word and the target word from a natural sentence as with the extraction section 155. For example, the extraction section 255 inputs the result of parsing performed by the parsing section 152 in the positive model indicated by the positive model information 244 in use of the model. Thus, the extraction section 255 extracts a pair of the relevant word defining the relevancy of “positive” and the target word from the natural sentence. Further, the extraction section 255 inputs the result of parsing performed by the parsing section 152 in the negative model indicated by the negative model information 245. Thus, the extraction section 255 extracts a pair of the relevant word defining the relevancy of “negative” and the target word from the natural sentence. Thus, the extraction section 255 extracts the pair of the relevant word and the target word corresponding to each relevancy using the model learnt for each relevancy defined by the relevant word.

For example, referring to FIG. 9, the extraction section 255 extracts and outputs the target words, such as “spec”, “performance”, and “lightweight”, by an input of a natural sentence after parsing in the positive model. Further, the extraction section 255 extracts and outputs the target words, such as “battery life, “easy to break”, and “price” by an input of a natural sentence similar to the input in the positive model in the negative model.

The preprocessing section 256 applies predetermined preprocessing to the result output by the extraction section 255 as with the preprocessing section 156. For example, the preprocessing section 256 applies preprocessing for visualizing the factor of the relevancy defined by the relevant word to the target word extracted by the extraction section 255.

For example, the preprocessing section 256 performs clustering using K-means or the like as the preprocessing. FIG. 10 illustrates an example of the result when the clustering, which is the preprocessing, is applied to the extraction example illustrated in FIG. 9. For example, the preprocessing section 256 organizes and visualizes the factors of the positive evaluations and the factors of the negative evaluations by clustering the results extracted and output by the extraction section 255 as illustrated in FIG. 10. The preprocessing section 256 may perform graphing or the like as with the first example embodiment.

The output section 257 outputs the result of the preprocessing performed by the preprocessing section 256 as with the output section 157. As described above, the factors of the positive evaluations and the factors of the negative evaluations are organized and visualized by the preprocessing performed by the preprocessing section 256. Therefore, according to the output by the output section 257, the factors of the positive evaluations and the factors of the negative evaluations can be easily confirmed.

The description above gives a configuration example of the extraction device 200. The operation of the extraction device 200 may be approximately similar to the operation of the extraction device 100, except that, due to the presence of the positive model and the negative model as the learnt model, the positive model and the negative model each are learnt and, in use, a natural sentence is input in each of the positive model and the negative model, and then the preprocessing is performed for each output.

Thus, the extraction device 200 has the extraction section 255. This configuration enables the extraction device 200 to extract the target word using the positive model and to also extract the target word using the negative model. This enables the extraction device 200 to extract and output the target word being a word indicating the factor of the relevant word defining the relevancy of “positive” and to also extract and output the target word being a word indicating the factor of the relevant word defining relevancy of “negative”.

The extraction device 200 may adopt a modification similar to that of the extraction device 100. This example embodiment describes that the extraction device 200 has both the positive model and the negative model as an example. However, the extraction device 200 may have only one of the positive model and the negative model.

### Third Example Embodiment

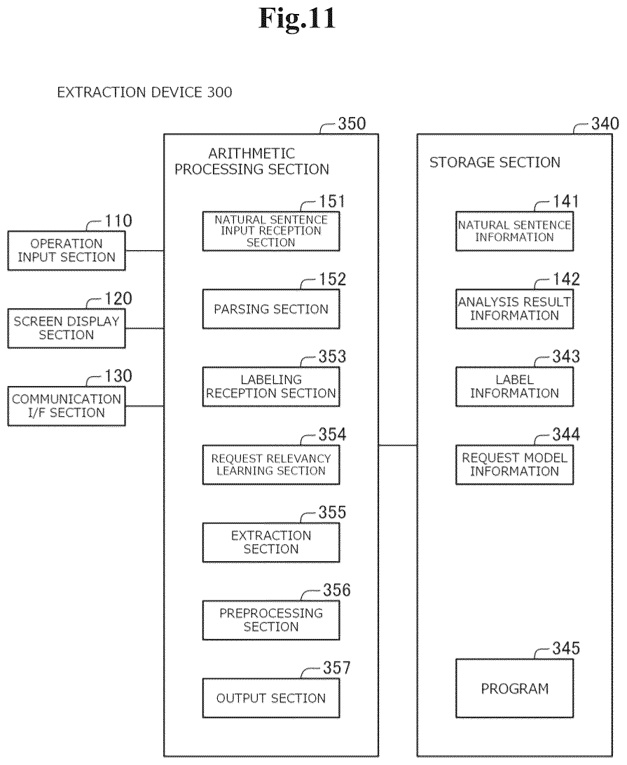

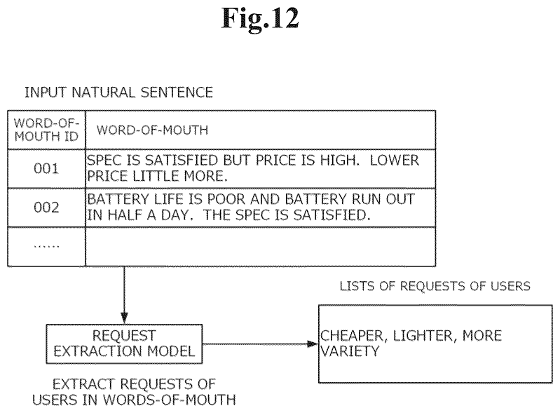

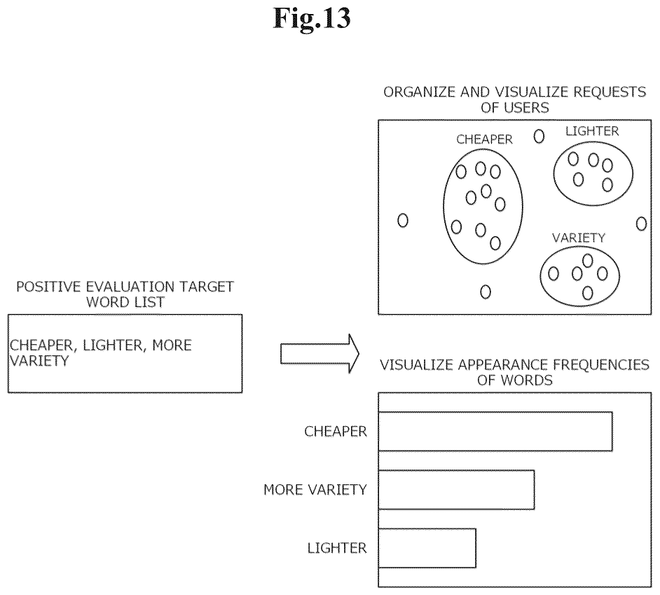

Next, a third example embodiment of this disclosure is described with reference to FIGS. 11 to 13. FIG. 11 is a block diagram illustrating a configuration example of an extraction device 300. FIG. 12 is a diagram illustrating an extraction example in the extraction device 300. FIG. 13 is a diagram illustrating an output example in the extraction device 300.

The third example embodiment of this disclosure describes the extraction device 300 that is an information processing device extracting and outputting at least one of a pair of the relevant word and the target word from an input natural sentence as with the extraction device 100 described in the first example embodiment and the extraction device 200 described in the second example embodiment. As described later, the extraction device 300 described in this example embodiment has a request model extracting a pair of the relevant word defining relevancy of “request” and the target word. Then, the extraction device 300 inputs natural sentences, such as words-of-mouth and product reviews, in the request model, thereby extracting the target word indicating the factor of the request (i.e., what a user requests). Further, the extraction device 300 performs clustering or graphing of the extracted target word, thereby accurately extracting a request of a user and making it possible to visually present the request.

FIG. 11 illustrates a configuration example of the extraction device 300. Referring to FIG. 11, the extraction device 300 has the operation input section 110, the screen display section 120, the communication I/F section 130, a storage section 340, and an arithmetic processing section 350, for example, as main constituent components.

FIG. 11 illustrates an example in which the functions of the extraction device 300 are realized using one information processing device, but various modifications may be adopted as the configuration of the extraction device 300 as with the extraction device 100 and the extraction device 200. Hereinafter, configurations characteristic in this example embodiment and different from the configurations of the extraction device 100 and the extraction device 200 among the configurations of the extraction device 300 are described.

The storage section 340 is a storage device, such as a hard disk or a memory. The storage section 340 stores processing information and a program 345 required for various kinds of processing in the arithmetic processing section 350. The program 345 realizes various processing sections by being read into the arithmetic processing section 350 to be executed. The program 345 is read in advance from an external device or a recoding medium via a data input/output function, such as the communication I/F section 130, to be stored in the storage section 240. Main information stored in the storage section 240 includes the natural sentence information 141, the analysis result information 142, label information 343, request model information 344, and the like, for example.

The label information 343 includes information according to results of labeling the words contained in the analysis result information 142. For example, the label information 343 is updated at each time when a labeling reception section 353 described later receives the labeling. In the case of this example embodiment, the label information 343 includes information indicating that a word is attached with a label indicating that the word is the relevant word defining the relevancy of “request” and information indicating that a word is attached with a label indicating that the word is the target word corresponding to the relevant word.

The request model information 344 includes a model that has been subjected to machine learning processing based on the labeled result. For example, the request model included in the request model information 344 is learnt and adjusted to extract and output the relevant word defining the relevancy of “request” and the target word for the input natural sentence (natural sentence after parsing). For example, the request model information 344 is updated in response to the learning performed by a request relevancy learning section 354 described later based on the result of labeling the relevant word defining the relevancy of “request” and the target word corresponding to the relevant word.

The arithmetic processing section 350 has an arithmetic processing device, such as the central processing unit (CPU), and peripheral circuits of the arithmetic processing device. The arithmetic processing section 350 reads the program 345 from the storage section 340 and executes the program 345, thereby making the hardware and the program 345 described above cooperate with each other and realizing various processing sections. Main processing sections realized by the arithmetic processing section 350 include the natural sentence input reception section 151, the parsing section 152, the labeling reception section 353, the request relevancy learning section 354, an extraction section 355, a preprocessing section 356, an output section 357, and the like, for example.

The labeling reception section 353 receives the attachment of labels to words by receiving an operation of an operator to the operation input section 110 after the parsing section 152 has performed the parsing in model learning. Then, the labeling reception section 353 stores information indicating the received label as the label information 343 in the storage section 340.

In the case of this example embodiment, the labeling reception section 353 receives labels for the relevant word defining the relevancy of “request” and the target word corresponding to the relevant word. The labeling reception section 353 may receive the labeling from an external device or the like as with the labeling reception section 153 described in the first example embodiment and the labeling reception section 253.

The request relevancy learning section 354 learns a model to extract and output the relevant word and the target word for the input natural sentence after parsing by adjusting a weight value in a weight matrix, for example, with the result received by the labeling reception section 353 and the parsing result as an input as with the relevancy learning section 154 and the positive/negative learning section 254. In the case of this example embodiment, the request relevancy learning section 354 learns a request model based on the labeled result. Thus, the request relevancy learning section 354 learns the request model that is a model according to the relevancy defined by the relevant word.

The extraction section 355 extracts and outputs a pair of the relevant word and the target word from a natural sentence as with the extraction section 155 and the extraction section 255. For example, the extraction section 355 inputs the result of parsing performed by the parsing section 152 in the request model indicated by the request model information 344 in use of the model. Thus, the extraction section 355 extracts the pair of the relevant word defining the relevancy of “request” and the target word from the natural sentence.

For example, FIG. 12 illustrates an extracted and output example when a natural sentence similar to that of the second example embodiment is input in the request model. Referring to FIG. 12, the extraction section 355 inputs the natural sentence after parsing in the request model, thereby extracting and outputting the target words, such as “cheaper”, “lighter”, and “more variety”. Thus, the extraction section 355 can extract and output the target word according to the relevancy defined by the relevant word.

The preprocessing section 356 applies predetermined preprocessing to the result output by the extraction section 355 as with the preprocessing section 156 and the preprocessing section 256. For example, the preprocessing section 356 applies preprocessing for visualizing the factor of the relevancy defined by the relevant word to the target word extracted by the extraction section 355.

For example, the preprocessing section 356 performs clustering using K-means or the like as the preprocessing. Further, the preprocessing section 356 totalizes the appearance frequencies of the word (target word), and then graphing the totalization result. FIG. 13 illustrates an example of the result when the clustering or the graphing, which is the preprocessing, is applied to an extraction example illustrated in FIG. 12. For example, the preprocessing section 356 organizes and visualizes the factors of the requests by clustering or graphing the extracted and output results as illustrated in FIG. 13.

The output section 357 outputs the result of the preprocessing performed by the preprocessing section 356 as with the output section 157 and the output section 257. As described above, the factors of the requests by users are organized and visualized by the preprocessing performed by the preprocessing section 356. Therefore, according to the output by the output section 357, the factors of the requests by users can be easily confirmed.

The description above gives a configuration example of the extraction device 300. The operation of the extraction device 300 may be approximately similar to that of the extraction device 100.

Thus, the extraction device 300 has the extraction section 355. This configuration enables the extraction device 300 to extract the target word using the request model. This enables the extraction device 300 to extract and output the target word being a word indicating the factor of the relevant word defining the relevancy of “request”.

The extraction device 300 may adopt modifications similar to those of the extraction device 100 and the extraction device 200. The extraction device 300 may also be combined with the extraction device 200, for example.

### Fourth Example Embodiment

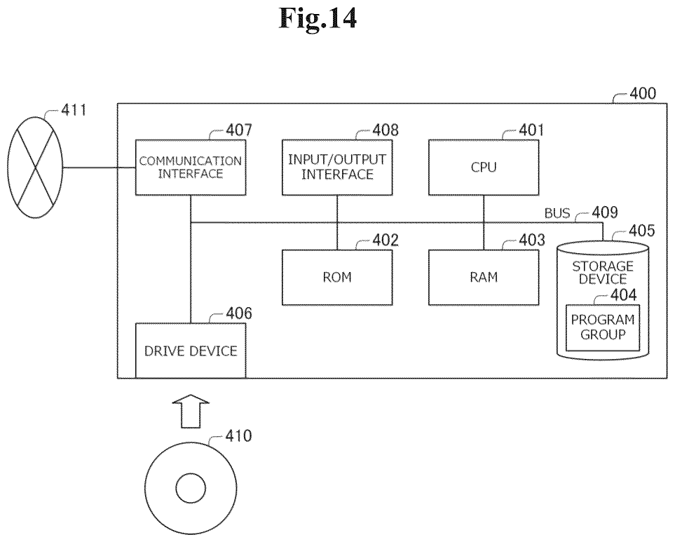

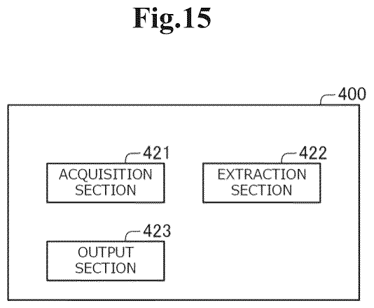

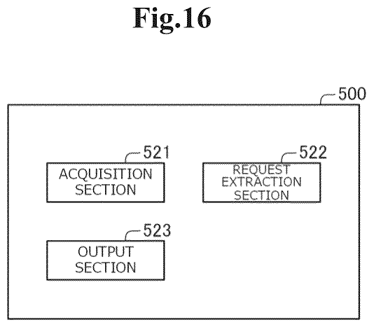

Next, a fourth example embodiment of this disclosure is described with reference to FIGS. 14 to 16. FIG. 14 is a diagram illustrating a hardware configuration example of an extraction device 400. FIG. 15 is a block diagram illustrating a configuration example of the extraction device 400. FIG. 16 is a block diagram illustrating a configuration example of a request extraction device 500.

The fourth example embodiment of this disclosure describes a configuration example of the extraction device 400. FIG. 14 illustrates a hardware configuration example of the extraction device 400. Referring to FIG. 14, the extraction device 400 has the hardware configuration described below as an example.
CPU (Central Processing Unit) 401 (arithmetic processing device)
Read only memory (ROM) 402 (storage device)
Random access memory (RAM) 403 (storage device)
Program group 404 loaded into RAM 403
Storage device 405 storing program group 404
Drive device 406 reading and writing data of recoding medium 410 outside information processing device
Communication interface 407 connected to communication network 411 outside information processing device
Input/output interface 408 inputting and outputting data
Bus 409 connecting each constituent components

The extraction device 400 can realize the functions as an acquisition section 421, an extraction section 422, and an output section 423 illustrated in FIG. 15 by the acquisition of the program group 404 by the CPU 401 and the execution of the program group 404 by the CPU 401. The program group 404 is stored in advance in the storage device 405 or in the ROM 402, and the CPU 401 loads the program group 404 into the RAM 403 or the like and executes the program group 404 as required, for example. The program group 404 may be supplied to the CPU 401 via the communication network 411, or may be stored in advance in the recoding medium 410, and the drive device 406 may read out the program and supply the program to the CPU 401.

FIG. 15 illustrates a hardware configuration example of the extraction device 400. The hardware configuration of the extraction device 400 is not limited to the cases described above. For example, the extraction device 400 may be configured by some of the configurations described above, e.g., not having the drive device 406.

The acquisition section 421 acquires the first natural sentence input by a user.

The extraction section 422 extracts at least the target word of the relevant word and the target word from the first natural sentence acquired by the acquisition section 421. For example, the extraction section 422 extracts at least the target word of the relevant word and the target word from the first natural sentence using a model learnt with a second natural sentence as an input to output the relevant word being a word defining the relevancy between words included in the second natural sentence and the target word being a word serving as the target of the target word.

For example, when the relevancy of “positive” is defined between words, words indicating positive feelings, such as “good” and “happy”, serve as the relevant word. For example, when the relevancy of “negative” is defined between words, words indicating negative feelings, such as “boring” and “bad”, serve as the relevant word.

The output section 423 outputs the target word extracted by the extraction section 422. For example, the output section 423 can transmit information according to the target word extracted by the extraction section 422 to an external device or cause a screen display section to display the information.

Thus, the extraction device 400 has the extraction section 422. This configuration enables the extraction device 400 to extract at least the target word of the relevant word and the target word for a natural sentence. As a result, the extraction device 400 can extract and output the target word being a word indicating the factor of the relevant word.

The above-described extraction device 400 can be realized by incorporation of a predetermined program in an information processing device, such as the extraction device 400. Specifically, the program, which is another form of the present invention, is a program for causing an information processing device, such as the extraction device 400, to realize processing of acquiring a first natural sentence input by a user, and extracting at least the target word of the relevant word and the target word from the acquired first natural sentence using a model learnt with a second natural sentence as an input to output the relevant word being a word defining the relevancy between words included in the second natural sentence and the target word being a word serving as the target of the relevant word, and outputting the extracted target word.

An extraction method executed by an information processing device, such as the above-described extraction device 400, is a method in which the information processing device, such as the extraction device 400, acquires a first natural sentence input by a user in an information processing device, such as the extraction device 400, extracts at least the target word of the relevant word and the target word from the acquired first natural sentence using a model learnt with a second natural sentence as an input to output the relevant word being a word defining the relevancy between words included in the second natural sentence and the target word being a word serving as the target of the relevant word, and outputs the extracted target word.

Even in the case of an invention related to the program, the computer-readable recoding medium storing the program, or the extraction method each having the above-described configuration, the invention has functions and effects similar to those of the above-described extraction device 400, and therefore can achieve the above-described object of the present invention.

FIG. 16 illustrates a request extraction device 500, which is an example of the extraction device 400. The hardware configuration of the request extraction device 500 may be similar to that of the extraction device 400. The request extraction device 500 can realize the functions of an acquisition section 521, a request extraction section 522, and an output section 523 illustrated in FIG. 16 by the acquisition of the program group 404 by the CPU 401 and the execution of the program group 404 by the CPU 401.

The acquisition section 521 acquires a first natural sentence input by a user.

The request extraction section 522 extracts at least the target word of the relevant word and the target word from the first natural sentence acquired by the acquisition section using a model learnt with a second natural sentence as an input to output the relevant word being a word indicating a request of a user included in the second natural sentence and the target word being a word serving as the target of the relevant word.

The output section 523 outputs the target word extracted by the request extraction section 522.

Thus, the request extraction device 500 has the request extraction section 522. This configuration enables the request extraction section 522 to extract at least the target word of the relevant word defining the relevancy of a request a from user and the target word for a natural sentence. As a result, a request of a user can be accurately extracted from natural sentences, such as words-of-mouth.

The above-described request extraction device 500 can be realized by incorporation of a specific program in an information processing device, such as the request extraction device 500. Specifically, the program, which is another form of the present invention, is a program for causing an information processing device, such as the extraction device 500, to realize processing of acquiring a first natural sentence input by a user, extracting at least the target word of the relevant word and the target word from the acquired first natural sentence using a model learnt with a second natural sentence as an input to output the relevant word being a word indicating a request of a user included in the second natural sentence and the target word that is the word serving as the target of the relevant word, and outputting the extracted target word.

A request extraction method executed by an information processing device, such as the above-described extraction device 500, is a method in which the information processing device, such as the extraction device 500, acquires a first natural sentence input by a user, extracts at least the target word of the relevant word and the target word from the acquired first natural sentence using a model learnt with a second natural sentence as an input to output the relevant word being a word indicating a request of a user included in the second natural sentence and the target word being a word serving as the target of the relevant word, and outputs the extracted target word.

Even in the case of an invention related to the program, the computer readable recoding medium storing the program, or the extraction method each having the above-described configuration, the invention has functions and effects similar to those of the above-described extraction device 500, and therefore can achieve the above-described object of the present invention.

### <Supplementary Notes>

The part or whole of the example embodiments described above can also be described as in the following supplementary notes. Hereinafter, the outline of the extraction device and the request extraction device, for example, in the present invention will be described. However, the present invention is not limited to the configurations described below.

### (Supplementary Note 1)

An extraction device including:
an acquisition section acquiring a first natural sentence input by a user:
an extraction section extracting at least a target word of a relevant word and the target word from the first natural sentence acquired by the acquisition section using a model learnt to output the relevant word and the target word with a second natural sentence as an input, the relevant word being a word defining the relevancy between words included in the second natural sentence and the target word being a word serving as the target of the relevant word; and an output section outputting the target word extracted by the extraction section.

### (Supplementary Note 2)

The extraction device according to Supplementary Note 1, in which
the extraction section extracts at least the target word of a pair of the target word and the relevant word corresponding to each relevancy using a plurality of models learnt for each relevancy defined by the relevant word.

### (Supplementary Note 3)

The extraction device according to Supplementary Note 1 or 2, in which
the extraction section extracts at least the target word of the relevant word indicating a positive feeling and the target word from the first natural sentence acquired by the acquisition section using a positive model extracting a pair of the relevant word indicating a positive feeling and the target word.

### (Supplementary Note 4)

The extraction device according to any one of Supplementary Notes 1 to 3, in which
the extraction section extracts at least the target word of the relevant word indicating a negative feeling and the target word from the first natural sentence acquired by the acquisition section using a negative model extracting a pair of the relevant word indicating a negative feeling and the target word.

### (Supplementary Note 5)

The extraction device according to any one of Supplementary Notes 1 to 4 including:
a learning section learning a model to extract and output the relevant word and the target word for a natural sentence using a result of labeling the relevant word and the target word for the second natural sentence after parsing, in which
the extraction section extracts at least the target word of the relevant word and the target word using a model learnt by the learning section.

### (Supplementary Note 6)

The extraction device according to Supplementary Note 5, in which
the learning section learns a model using the labeling result and feature amounts of words stored in advance.

### (Supplementary Note 7)

The extraction device according to any one of Supplementary Notes 1 to 6 including:
a preprocessing section applying preprocessing for visualizing a factor of relevancy of a request from a user defined by the relevant word to the target word extracted by the extraction section, in which
the output section outputs the result of the preprocessing performed by the preprocessing section.

### (Supplementary Note 8)

The extraction device according to Supplementary Note 7, in which
the preprocessing section applies clustering as the preprocessing to the target word extracted by the extraction section, and
the output section outputs the result of the clustering applied by the preprocessing section.

### (Supplementary Note 9)

An extraction method including:
acquiring a first natural sentence input by a user;
extracting at least a target word of a relevant word and the target word from the acquired first natural sentence using a model learnt to output the relevant word and the target word with a second natural sentence as an input, the relevant word being a word defining the relevancy between words included in the second natural sentence and the target word being a word serving as the target of the relevant word; and
outputting the extracted target word,
the acquiring, the extracting, and the outputting being performed by an information processing device.

### (Supplementary Note 10)

A computer-readable recording medium storing a program for causing an information processing device to realize processing of:
acquiring a first natural sentence input by a user:
extracting at least a target word of a relevant word and the target word from the acquired first natural sentence using a model learnt to output the relevant word and the target word with a second natural sentence as an input, the relevant word being a word defining the relevancy between words included in the second natural sentence and the target word being a word serving as the target of the relevant word; and
outputting the extracted target word.

### (Supplementary Note 11)

A request extraction device including:
an acquisition section acquiring a first natural sentence input by a user:
a request extraction section extracting at least a target word of a relevant word and the target word from the first natural sentence acquired by the acquisition section using a model learnt to output the relevant word and the target word with a second natural sentence as an input, the relevant word being a word indicating a request of a user included in the second natural sentence and the target word being a word serving as the target of the relevant word; and
an output section outputting the target word extracted by the request extraction section.

### (Supplementary Note 12)

The request extraction device according to Supplementary Note 11 including:
a preprocessing section applying preprocessing for visualizing a factor of relevancy of a request from a user defined by the relevant word to the target word extracted by the request extraction section, in which
the output section outputs the result of the preprocessing performed by the preprocessing section.

### (Supplementary Note 13)

The request extraction device according to Supplementary Note 12, in which
the preprocessing section applies clustering as the preprocessing to the target word extracted by the extraction section, and
the output section outputs the result of the clustering applied by the preprocessing section.

### (Supplementary Note 14)

The request extraction device according to Supplementary Note 12 or 13, in which
the preprocessing section totalizes and graphs appearance frequencies of the target word extracted as the preprocessing for the target word extracted by the request extraction section; and
the output section outputs the result of the graphing performed by the preprocessing section.

### (Supplementary Note 15)

The request extraction device according to any one of Supplementary Notes 11 to 14 including:
a request learning section learning a model to extract and output the relevant word being the word indicating a request of a user and the target word serving as the target of the relevant word for a natural sentence using a result of labeling the relevant word and the target word for the second natural sentence after parsing, in which
the request extraction section extracts at least the target word of the relevant word and the target word using a model learnt by the request learning section.

### (Supplementary Note 16)

The request extraction device according to Supplementary Note 15, in which
the request learning section learns a model using the labeling result and feature amounts of words stored in advance.

### (Supplementary Note 17)

A request extraction method including:
acquiring a first natural sentence input by a user;
extracting at least a target word of a relevant word and the target word from the acquired first natural sentence using a model learnt to output the relevant word and the target word with a second natural sentence as an input, the relevant word being a word indicating a request of a user included in the second natural sentence and the target word being a word serving as the target of the relevant word; and
outputting the extracted target word,
the acquiring, the extracting, and the outputting being performed by an information processing device.

### (Supplementary Note 18)

The request extraction method according to Supplementary Note 17 including:
applying preprocessing for visualizing a factor of relevancy of a request from a user defined by the relevant word to the extracted target word; and
outputting the result of the preprocessing.

### (Supplementary Note 19)

A computer-readable recording medium storing a program for causing an information processing device to realize processing of:
acquiring a first natural sentence input by a user;
extracting at least a target word of a relevant word and the target word from the acquired first natural sentence using a model learnt to output the relevant word and the target word with a second natural sentence as an input, the relevant word being a word indicating a request of a user included in the second natural sentence and the target word being a word serving as the target of the relevant word; and
outputting the extracted target word.

### (Supplementary Note 20)

The computer-readable recording medium according to Supplementary Note 19 storing a program of:
applying preprocessing for visualizing a factor of relevancy of a request from a user defined by the relevant word to the target word extracted, and
outputting the result of the preprocessing.

As described above, the invention of this application has been described with reference to the example embodiments described above, but the invention of this application is not limited to the above-described example embodiments. The configurations and the details of the invention of this application can be altered in various ways that can be understood by those skilled in the art within the scope of the invention of this application.

### REFERENCE SIGNS LIST

100 extraction device
110 operation input section
120 screen display section
130 communication I/F section
140 storage section
141 natural sentence information
142 analysis result information
143 label information
144 learnt model
145 program
146 word feature amount DB
150 arithmetic processing section
151 natural sentence input reception section
152 parsing section
153 labeling reception section
154 relevancy learning section
155 extraction section
156 preprocessing section
157 output section
200 extraction device
240 storage section
243 label information
244 positive model information
245 negative model information
246 program
250 arithmetic processing section
253 labeling reception section
254 positive/negative relevancy learning section
255 extraction section
256 preprocessing section
257 output section
300 extraction device
340 storage section
343 label information
344 request model information
345 program
350 arithmetic processing section
353 labeling reception section
354 request relevancy learning section
355 extraction section
356 preprocessing section
357 output section
400 extraction device
401 CPU
402 ROM
403 RAM
404 program group
405 storage device
406 drive device
407 communication interface
408 input/output interface
409 bus
410 recoding medium
411 communication network
421 acquisition section
422 extraction section
423 output section
500 request extraction device
521 acquisition section
522 request extraction section
523 output section

What is claimed is:

1. An extraction device comprising:
at least one memory storing a processing instruction; and
at least one processor configured to execute the processing instruction,
the at least one processor acquiring a first natural sentence input by a user,
extracting at least a target word of a relevant word and the target word from the first natural sentence acquired by the acquisition section using a model learnt to output the relevant word and the target word with a second natural sentence as an input, the relevant word being a word defining relevancy between words included in the second natural sentence and a target word being a word serving as a target of the relevant word, and
outputting the target word extracted by the extraction section.

2. The extraction device according to claim 1, wherein
the at least one processor configured to execute the processing instruction extracts at least the target word of a pair of the target word and the relevant word corresponding to each relevancy using a plurality of models learnt for each relevancy defined by the relevant word.

3. The extraction device according to claim 1, wherein
the at least one processor configured to execute the processing instruction extracts at least the target word of the relevant word indicating a positive feeling and the target word from the first natural sentence acquired by the acquisition section using a positive model extracting a pair of the relevant word indicating a positive feeling and the target word.

4. The extraction device according to claim 1, wherein
the at least one processor configured to execute the processing instruction extracts at least the target word of the relevant word indicating a negative feeling and the target word from the first natural sentence acquired by the acquisition section using a negative model extracting a pair of the relevant word indicating a negative feeling and the target word.

5. The extraction device according to claim 1, wherein
the at least one processor configured to execute the processing instruction learns a model to extract and output the relevant word and the target word for a natural sentence using a result of labeling the relevant word and the target word for the second natural sentence after parsing, and
extracts at least the target word of the relevant word and the target word using a model learnt by the learning section.

6. The extraction device according to claim 5, wherein
the at least one processor configured to execute the processing instruction learns a model using the labeling result and feature amounts of words stored in advance.

7. The extraction device according to claim 1, wherein
the at least one processor configured to execute the processing instruction applies preprocessing for visualizing a factor of relevancy of a request from a user defined by the relevant word to the target word extracted by the extraction section, and
outputs a result of the preprocessing performed by the preprocessing section.

8. The extraction device according to claim 7, wherein
the at least one processor configured to execute the processing instruction applies clustering as the preprocessing to the target word extracted by the extraction section, and
outputs a result of the clustering applied by the preprocessing section.

9. An extraction method comprising:
acquiring a first natural sentence input by a user;
extracting at least a target word of a relevant word and the target word from the acquired first natural sentence using a model learnt to output the relevant word and the target word with a second natural sentence as an input, the relevant word being a word defining relevancy between words included in the second natural sentence and the target word being a word serving as a target of the relevant word; and
outputting the extracted target word,
the acquiring, the extracting, and the outputting being performed by an information processing device.

10. A computer-readable recording medium storing a program for causing an information processing device to realize processing of:
acquiring a first natural sentence input by a user;
extracting at least a target word of a relevant word and the target word from the acquired first natural sentence using a model learnt to output the relevant word and the target word with a second natural sentence as an input, the relevant word being a word defining relevancy between words included in the second natural sentence and the target word being a word serving as a target of the relevant word; and
outputting the extracted target word.
